(19) United States
(12) Patent Application Publication
(10) Pub. No.: US 2015/0160369 A1
(43) Pub. Date: Jun. 11, 2015

(54) METHOD FOR WELL PLACEMENT

(71) Applicant: KING FAHD UNIVERSITY OF PETROLEUM AND MINERALS, Dhahran (SA)

(72) Inventors: ABEEB ADEBOWALE AWOTUNDE, Dhahran (SA); NAJMUDEEN SIBAWEIHI, Thoqba (SA)

(21) Appl. No.: 14/489,425

(22) Filed: Sep. 17, 2014

Related U.S. Application Data
(60) Provisional application No. 61/913,868, filed on Dec. 9, 2013.

(51) Int. Cl. G01V 11/00; G06F 17/13

(52) U.S. Cl. CPC G01V 11/00; G06F 17/13

(57) ABSTRACT

The method for well placement is a computerized optimization method using net present value (NPV) and voidage replacement ratio (VRR) in waterflooding as simultaneous objective functions in the determination of the optimal location of wells. The objective function of the overall multiobjective optimization problem is evaluated as a weighted sum of the NPV and the VRR. The method of well placement uses an evolutionary algorithm to optimize the multiobjective function Φ_{MOBJ} to maximize net present value (NPV) and to minimize voidage imbalance ratio (VIR), where the VIR is given by VIR=VRR−1, where the voidage replacement ratio (VRR) is a ratio of the total volume of fluid injected to the volume of fluid produced.

### CROSS-REFERENCE TO RELATED APPLICATION

This application claims the benefit of U.S. Provisional Patent Application Ser. No. 61/913,868, filed on Dec. 9, 2013.

### BACKGROUND OF THE INVENTION

1. Field of the Invention

The present invention relates to placement of oil wells in oil reservoirs where waterflooding is used, and particularly to a computer-implemented method for well placement that considers the dual objectives of using net present value (NPV) and voidage replacement ratio (VRR).

2. Description of the Related Art

Waterflooding is the use of water injection to increase the production from oil reservoirs. Use of water to increase oil production is known as “secondary recovery” and typically follows “primary production”, which uses the reservoir's natural energy (fluid and rock expansion, solution-gas drive, gravity drainage, and aquifer influx) to produce oil. The principal reason for waterflooding an oil reservoir is to increase the oil-production rate, and ultimately, the oil recovery. This is accomplished by “voidage replacement”, which is the injection of water to increase the reservoir pressure to its initial level and maintain it near that pressure. The water displaces oil from the pore spaces, but the efficiency of such displacement depends on many factors, such as oil viscosity and rock characteristics. The “voidage replacement ratio” (VRR) is the ratio of reservoir barrels of injected fluid to reservoir barrels of produced fluid.

Typical well placement optimization methods are based on a single objective function for the determination of the best location for placing wells, namely, either the net present value (NPV) of the waterflood project or the recovery efficiency. The NPV measures the profitability of investment discounted to the present time, which is usually the beginning of the project. The NPV measure of profitability is of great interest to investors, who are most often driven by maximum returns on investments. The use of the NPV as the sole objective function in an optimization process often leads to the most profitable scenario (i.e., the most profitable scenario given the available computational resources), but does not take into consideration other factors, such as environmental impact.

In order to identify the trade-offs between high profitability of investment in oil and gas projects and the desire to satisfy regulatory and environmental requirements, it would be desirable to develop an optimization method for well placement combining both the NPV and VRR as objective functions.

Thus, a method for well placement addressing the aforementioned problems is desired.

### SUMMARY OF THE INVENTION

The method for well placement is a computerized optimization method using net present value (NPV) and voidage replacement ratio (VRR) in waterflooding as simultaneous objective functions in the determination of the optimal location of wells. The objective function of the overall optimization problem is evaluated as a weighted sum of the NPV and the VRR. The method uses an evolutionary algorithm to optimize the multiobjective function Φ_{MOBJ} to maximize net present value (NPV) and to minimize voidage imbalance ratio (VIR), where the VIR is given by VIR=VRR−1 and the voidage replacement ratio (VRR) is a ratio of the total volume of fluid injected to the volume of fluid produced.

Optimization of the multiobjective function is performed iteratively with an evolutionary algorithm. Thus, for the κ-th iteration:

$${Φ}_{MOBJ , κ} = - \frac{{NPV}_{κ}}{{β}_{{NPV}_{κ = 1}}} + \frac{1}{α} {\sum }_{n = 1}^{N} \frac{{\vert VIR \vert}_{n , κ}}{{β}_{{\vert VIR \vert}_{n , κ = 1}}} ,$$

where β_{NPV}_{_{κ=1}} is a scaling factor chosen as the median fitness value in the population at the first generation, and similarly, β_{|VIR|}_{_{n,κ=1}} is a scaling factor chosen as the median fitness value in the population at the first generation at the n-th year, where n ranges between one and N and N is the total number of years of reservoir waterflooding. The constant α is also a scaling factor, which is an integer value ranging between one and N. The value Φ_{MOBJ} is a function of well position \vec{x}, and the ultimate solution to the optimization problem is to find the well position \vec{x} that optimizes Φ_{MOBJ} by maximizing NPV and minimizing VIR. The absolute VIR for year n is given by |VIR|ₙ=|1−VRRₙ|, where:

$${VRR}_{n} = \frac{{B}_{w , n} {Q}_{n}^{w , inj}}{{B}_{w , n} {Q}_{n}^{w , pro} + {B}_{o , n} {Q}_{n}^{o , pro} + {B}_{g , n} {Q}_{n}^{o , pro} ( {GOR}_{n} - {R}_{so , n} )} ,$$

and where B_{w,n}, B_{o,n} and B_{g,n} are the average formation volume factors for water, oil and gas in year n, respectively, Qₙ^{w,inj} and Qₙ^{w,pro} are the total amount of water injected and produced, respectively, in year n, Qₙ^{o,pro} is the total amount of oil produced in year n, GORₙ is the cumulative gas/oil ratio in year n, and R_{so,n} is the solution-gas/oil ratio in year n.

The NPV for a waterflood project is given as:

$$NPV = {\sum }_{n = 1}^{N} \frac{{CF}_{n}}{{( 1 + r )}^{n}} - {C}_{cap} ,$$

where CFₙ is the cash flow in year n, r is the annual discount rate, and C_{cap} is the capital expense, given by C_{cap}=C_{facility}+N_{prod}C_{prod}+NᵢₙⱼCᵢₙⱼ, where C_{facility} is the facility-installation cost, N_{prod} is the number of producers, C_{prod} is the cost of drilling one production well, Nᵢₙⱼ is the number of injectors, and Cᵢₙⱼ is the cost of drilling an injector.

These and other features of the present invention will become readily apparent upon further review of the following specification.

### BRIEF DESCRIPTION OF THE DRAWINGS

FIG. 1 is a block diagram illustrating system components for implementing the method for well placement according to the present invention.

FIG. 2 is a graphic representation of a first layer of an exemplary channel reservoir used in a first example of the method for well placement according to the present invention.

FIG. 3 is a graphic representation of a second layer of the exemplary channel reservoir of FIG. 2.

FIG. 4 is a graphic representation of permeability distribution of the exemplary channel reservoir of FIGS. 2 and 3.

FIG. 5A is a graph showing net present value (NPV) calculated for multiple cases of the first example of FIGS. 2-4 using a covariance matrix adaptation evolution strategy (CMA-ES) optimization algorithm.

FIG. 5B is a graph showing net present value (NPV) calculated for multiple cases of the first example of FIGS. 2-4 using a differential evolution (DE) optimization algorithm.

FIG. 6A is a graph showing “worst” voidage replacement ratio (VRR) calculated for multiple cases of FIGS. 2-4 using a covariance matrix adaptation evolution strategy (CMA-ES) optimization algorithm.

FIG. 6B is a graph showing “worst” voidage replacement ratio (VRR) calculated for multiple cases of the first example of FIGS. 2-4 using a differential evolution (DE) optimization algorithm.

FIG. 7A is a graph showing “best” voidage replacement ratio (VRR) calculated for multiple cases of the first example of FIGS. 2-4 using a covariance matrix adaptation evolution strategy (CMA-ES) optimization algorithm.

FIG. 7B is a graph showing “best” voidage replacement ratio (VRR) calculated for multiple cases of the first example of FIGS. 2-4 using a differential evolution (DE) optimization algorithm.

FIG. 8A is a plot showing optimized two-dimensional well locations computed using a single NPV-based objective function in the first example of FIGS. 2-4.

FIG. 8B is a plot showing optimized two-dimensional well locations computed using a single VRR-based objective function in the first example of FIGS. 2-4.

FIG. 8C is a plot showing optimized two-dimensional well locations computed using multi-objective method of well placement with a weighting scale factor of α=1 in the first example of FIGS. 2-4.

FIG. 8D is a plot showing optimized two-dimensional well locations computed using multi-objective method of well placement with a weighting scale factor of α=5 in the first example of FIGS. 2-4.

FIG. 8E is a plot showing optimized two-dimensional well locations computed using multi-objective method of well placement with a weighting scale factor of α=15 in the first example of FIGS. 2-4.

FIG. 8F is a plot showing optimized two-dimensional well locations computed using multi-objective method of well placement with a weighting scale factor of α=20 in the first example of FIGS. 2-4.

FIG. 9 is a graphical representation of the log permeability distribution of a hypothetical channel reservoir in a second example of the method for well placement according to the present invention.

FIG. 10A is a graph showing net present value (NPV) calculated for multiple cases of the second example of FIG. 9 using a covariance matrix adaptation evolution strategy (CMA-ES) optimization algorithm.

FIG. 10B is a graph showing net present value (NPV) calculated for multiple cases of the second example of FIG. 9 using a differential evolution (DE) optimization algorithm.

FIG. 11A is a graph showing “worst” voidage replacement ratio (VRR) calculated for multiple cases of the second example of FIG. 9 using a covariance matrix adaptation evolution strategy (CMA-ES) optimization algorithm.

FIG. 11B is a graph showing “worst” voidage replacement ratio (VRR) calculated for multiple cases of the second example of FIG. 9 using a differential evolution (DE) optimization algorithm.

FIG. 12A is a graph showing “best” voidage replacement ratio (VRR) calculated for multiple cases of the second example of FIG. 9 using a covariance matrix adaptation evolution strategy (CMA-ES) optimization algorithm.

FIG. 12B is a graph showing “best” voidage replacement ratio (VRR) calculated for multiple cases of the second example of FIG. 9 using a differential evolution (DE) optimization algorithm.

FIG. 13A is a plot showing optimized two-dimensional well locations computed using a single NPV-based objective function in the second example of FIG. 9.

FIG. 13B is a plot showing optimized two-dimensional well locations computed using a single VRR-based objective function in the second example of FIG. 9.

FIG. 13C is a plot showing optimized two-dimensional well locations computed using multi-objective method of well placement with a weighting scale factor of α=0.1 in the second example of FIG. 9.

FIG. 13D is a plot showing optimized two-dimensional well locations computed using multi-objective method of well placement with a weighting scale factor of α=1 in the second example of FIG. 9.

FIG. 13E is a plot showing optimized two-dimensional well locations computed using multi-objective method of well placement with a weighting scale factor of α=6 in the second example of FIG. 9.

FIG. 13F is a plot showing optimized two-dimensional well locations computed using multi-objective method of well placement with a weighting scale factor of α=12 in the second example of FIG. 9.

FIG. 14 is a graphical representation of the permeability distribution of a channel reservoir of a third example of the method for well placement according to the present invention.

FIG. 15A is a graph showing net present value (NPV) calculated for multiple cases of the third example of FIG. 14 using a covariance matrix adaptation evolution strategy (CMA-ES) optimization algorithm.

FIG. 15B is a graph showing net present value (NPV) calculated for multiple cases of the third example of FIG. 14 using a differential evolution (DE) optimization algorithm.

FIG. 16A is a graph showing “worst” voidage replacement ratio (VRR) calculated for multiple cases of the third example of FIG. 14 using a covariance matrix adaptation evolution strategy (CMA-ES) optimization algorithm.

FIG. 16B is a graph showing “worst” voidage replacement ratio (VRR) calculated for multiple cases of the third example of FIG. 14 using a differential evolution (DE) optimization algorithm.

FIG. 17A is a graph showing “best” voidage replacement ratio (VRR) calculated for multiple cases of FIG. 14 using a covariance matrix adaptation evolution strategy (CMA-ES) optimization algorithm.

FIG. 17B is a graph showing “best” voidage replacement ratio (VRR) calculated for multiple cases of FIG. 14 using a differential evolution (DE) optimization algorithm.

FIG. 18A is a plot showing optimized two-dimensional well locations computed using a single NPV-based objective function in the third example of FIG. 14.

FIG. 18B is a plot showing optimized two-dimensional well locations computed using a single VRR-based objective function in the third example of FIG. 14.

FIG. 18C is a plot showing optimized two-dimensional well locations computed using multi-objective method of well placement with a weighting scale factor of α=1 in the third example of FIG. 14.

FIG. 18D is a plot showing optimized two-dimensional well locations computed using multi-objective method of well placement with a weighting scale factor of α=5 in the third example of FIG. 14.

FIG. 18E is a plot showing optimized two-dimensional well locations computed using multi-objective method of well placement with a weighting scale factor of α=15 in the third example of FIG. 14.

FIG. 18F is a plot showing optimized two-dimensional well locations computed using multi-objective method of well placement with a weighting scale factor of α=25 in the third example of FIG. 14.

Unless otherwise indicated, similar reference characters denote corresponding features consistently throughout the attached drawings.

### DETAILED DESCRIPTION OF THE PREFERRED EMBODIMENTS

The method for well placement views the problem of well placement in an oil field where waterflooding is used to maximize production as a multiobjective problem that can be solved using a computer system that implements an evolutionary algorithm for solving a multiobjective optimization problem. In particular, the method optimizes a multiobjective function Φ_{MOBJ} to maximize net present value (NPV) and minimize voidage imbalance ratio (VIR), where the VIR is given by VIR=VRR−1 and where the voidage replacement ratio (VRR) is a ratio of the total volume of fluid injected to the volume of fluid produced. Optimization of the multiobjective function is performed iteratively with an evolutionary algorithm. Thus, for the κ-th iteration:

$${Φ}_{MOBJ , κ} = - \frac{{NPV}_{κ}}{{β}_{{NPV}_{κ = 1}}} + \frac{1}{α} {\sum }_{n = 1}^{N} \frac{{\vert VIR \vert}_{n , κ}}{{β}_{{\vert VIR \vert}_{n , κ = 1}}} ,$$

where β_{NPV}_{_{κ=1}} is a scaling factor chosen as the median fitness value in the population at the first generation and, similarly, β_{|VIR|}_{_{n,κ=1}} is a scaling factor chosen as the median fitness value in the population at the first generation at the n-th year, where n ranges between one and N, where N is the total number of years of reservoir waterflooding. The constant α is also a scaling factor, which is an integer value ranging between one and N. The function Φ_{MOBJ} is a function of well position \vec{x} and the ultimate solution to the optimization problem is to find the well position \vec{x} that optimizes Φ_{MOBJ} by maximizing NPV and minimizing VIR. The absolute VIR for year n is given by |VIR|ₙ=|1−VRRₙ|, where:

$${VRR}_{n} = \frac{{B}_{w , n} {Q}_{n}^{w , inj}}{{B}_{w , n} {Q}_{n}^{w , pro} + {B}_{o , n} {Q}_{n}^{o , pro} + {B}_{g , n} {Q}_{n}^{o , pro} ( {GOR}_{n} - {R}_{so , n} )} ,$$

where B_{w,n}, B_{o,n} and B_{g,n} are the average formation volume factors for water, oil and gas in year n, respectively, Qₙ^{w,inj} and Qₙ^{w,pro} are the total amount of water injected and produced, respectively, in year n, Qₙ^{o,pro} is the total amount of oil produced in year n, GORₙ is the cumulative gas/oil ratio in year n, and R_{so,n} is the solution-gas/oil ratio in year n.

The NPV for a waterflood project is given as:

$$NPV = {\sum }_{n = 1}^{N} \frac{{CF}_{n}}{{( 1 + r )}^{n}} - {C}_{cap} ,$$

where CFₙ is the cash flow in year n, r is the annual discount rate, and C_{cap} is the capital expense, given by C_{cap}=C_{facility}+N_{prod}C_{prod}+NᵢₙⱼCᵢₙⱼ, where C_{facility} is the facility-installation cost, N_{prod} is the number of producers, C_{prod} is the cost of drilling one production well, Nᵢₙⱼ is the number of injectors, and Cᵢₙⱼ is the cost of drilling an injector.

The cash flow in year n is calculated as CFₙ=Rₙ−Eₙ, where Rₙ is the total revenue for year n, given by Rₙ=Pₙ^{o}Qₙ^{o,pro}+Pₙ^{g}Qₙ^{g,pro}, where Pₙ^{o} and Pₙ^{g} are the price of oil and gas in year n, respectively, and Qₙ^{o,pro} and Qₙ^{g,pro} are the total oil and gas produced in year n, respectively. Eₙ is the total operating expenditure in year n, given by Eₙ=Cₙ^{w,pro}Qₙ^{w,pro}+Cₙ^{w,inj}Qₙ^{w,inj}+C_{op,n}, where Qₙ^{w,pro} and Qₙ^{w,inj} are the total amount of water produced and water injected in year n, respectively, Cₙ^{w,inj} is the cost of acquiring, treating and injecting a barrel of water, Cₙ^{w,pro} is the cost of treating/disposing of a barrel of water produced, and C_{op,n} is the operating cost per barrel of oil produced in year n.

Generally, objective functions are performance measures that indicate the quality of different alternatives, thereby guiding an optimization algorithm towards finding the optimal solution(s) to a problem. The different alternatives are the “candidate solutions” or “agents” in each generation. Thus, the objective function measures the quality of these candidates and is used in the selection stage via a process similar to evolutionary survival of the fittest. When only a single objective, such as the net present value (NPV), is involved, the optimization is considered to be “single objective”. However, when two or more conflicting objectives are optimized, the optimization process is considered to be “multi-objective” (or multiobjective).

In general, an optimization problem involving only one objective is typically presented as:

$${min}_{\vec{x}} Φ ( \vec{x} ) \qquad ( 1 )$$

subject to the conditions:

\vec{x}ε{\vec{x}ε [symbol] ⁿ|gᵢ(\vec{x})≦0,i=1,2, . . . N_{C}}, (2)

where Φ is the objective function, gᵢ(\vec{x}) are the constraints and N_{c} is the number of constraints. In order to properly evaluate the usefulness of the multi-objective strategy used in the present method, well placement optimization using the NPV as a single performance measure is presented for purposes of comparison against using the weighted sum of the absolute voidage imbalance ratio (VIR) as a performance measure. In a minimization process, the objective function for the NPV at each generation c is given as:

Φ_{NPV,κ}=−NPV_{κ}, (3)

and the objective function for the voidage replacement ratio (VRR) at generation κ is given by:

$${Φ}_{VRR , κ} = {\sum }_{n = 1}^{N} \frac{{\vert V I R \vert}_{n , κ}}{{β}_{{\vert V I R \vert}_{n , κ = 1}}} \qquad ( 4 )$$

where β_{|VIR|}_{_{n,κ=1}} is the scaling factor for |VIR| at the n-th year. This scale factor is taken at the first iteration. It is assumed that the VRRs in all years are of equal importance, and as such, are not conflicting objectives. Thus, Φ_{VRR} is treated as a single objective including the weighted sum of the VRRs in all years.

A multi-objective optimization problem, involving simultaneous optimization of two or more conflicting objectives, is stated generally as:

$${min}_{{x}^{->}} [ {Φ}_{1} ( {x}^{->} ) , {Φ}_{2} ( {x}^{->} ) , … , {Φ}_{{N}_{obj}} ( {x}^{->} ) ] , \qquad ( 5 )$$

subject to:

\vec{x}ε{\vec{x}ε [symbol] ⁿ|gᵢ(\vec{x})≦0,i=1,2, . . . ,N_{c}}, (6)

where Φ₁(\vec{x}), Φ₂(\vec{x}), . . . , Φ_{N}_{_{obj}}(\vec{x}) are conflicting objectives and N_{obj} is the number of objectives to be optimized. In order to handle the multiple, and usually conflicting, objectives, a weighted sum of the objectives is used in the present method. The NPV is one objective and the absolute VIR for each discounting period (i.e., year) is also an objective. Thus, in total, there are N+1 objectives, where N is the number of operating periods. However, because the VIRs are treated as similar objectives, they are aggregated into a single objective, leading to only two objectives, namely, the NPV and a weighted sum of all VIRs. Thus, for each candidate solution or agent \vec{x}ⱼ, the multi-objective function to be optimized at generation κ, Φ_{MOBJ,κ}, is given by:

$${Φ}_{MOBJ , κ} = - \frac{N P {V}_{κ}}{{β}_{{NPV}_{κ = 1}}} + \frac{1}{α} {\sum }_{n = 1}^{N} \frac{{\vert V I R \vert}_{n \cdot κ}}{{β}_{{\vert V I R \vert}_{n , κ = 1}}} , \qquad ( 7 )$$

where the βs are scaling factors that ensure all the objectives are within the same scale. In the present method, the βs are chosen to be the median fitness value in the population at the first generation. The parameter α is a scaling factor that determines the importance of the NPV relative to the VRR. Thus, the value of this parameter depends on the importance an operator attaches to the NPV or the VRR. A large value of α will lead to a high NPV, but at the expense of the VRR, while a small value of α will typically lead to a low NPV.

Each agent in the population has one NPV value and N VIR values. This is because for each operating year, a VIR is computed, and each absolute VIR value serves as an objective. In order to bring the various objectives to the same scale of resolution, it is necessary to find appropriate scaling factors for each objective. In the present method, the median fitness (objective) in the population at the first generation is chosen as the scaling factor for each objective. However, other statistical parameters, such as the mean or maximum value in the population, could be used in place of the median. At the first generation, the median of the NPVs of the agents in the population is computed and used for scaling the NPVs at the first and subsequent generations. Additionally, at the first generation, the median of the absolute VIRs of the agent for each year is computed and used to scale the absolute VIRs of each agent at the corresponding year for all generations. An example is presented in Table 1 to illustrate how the scaling factors are determined. In Table 1, the NPV and absolute VIRs of five agents in an evolutionary strategy are presented for an 8-year project. The values were recorded at the first generation. The last column of the table contains the values of β. In Table 1, the NPV is presented in U.S. dollars (USD).

TABLE 1
Example of Determination of Scaling Parameters

| Objectives | Agent 1 | Agent 2 | Agent 3 | Agent 4 | Agent 5 | β |
|---|---|---|---|---|---|---|
| NPV (USD) | 7 × 10⁹ | 3 × 10⁹ | 5 × 10⁹ | 8 × 10⁹ | 6 × 10⁹ | 6 × 10⁹ |
| \|VIR\|_{1, K=1} | 1.24 | 0.62 | 0.50 | 0.47 | 0.67 | 0.62 |
| \|VIR\|_{2, K=1} | 0.60 | 0.87 | 1.21 | 0.7 | 0.68 | 0.7 |
| \|VIR\|_{3, K=1} | 0.82 | 0.93 | 0.70 | 0.78 | 0.86 | 0.82 |
| \|VIR\|_{4, K=1} | 0.65 | 0.87 | 1.30 | 1.05 | 0.92 | 0.92 |
| \|VIR\|_{5, K=1} | 0.95 | 0.75 | 1.12 | 1.32 | 0.80 | 0.95 |
| \|VIR\|_{6, K=1} | 1.10 | 0.67 | 0.89 | 0.95 | 0.92 | 0.92 |
| \|VIR\|_{7, K=1} | 1.20 | 0.97 | 0.94 | 1.03 | 1.14 | 1.03 |
| \|VIR\|_{8, K=1} | 1.13 | 1.15 | 0.96 | 0.94 | 1.35 | 1.13 |

Three example well placement optimization problems have been solved using the present method. Each of these problems was solved to determine the optimized location of wells and to determine the effect of the weight parameter a on the optimized NPV and VRRs. To solve the optimization problems, the CMA-ES and DE algorithms were employed as optimizers. The Covariance Matrix Adaptation Evolution Strategy (CMA-ES) is a type of evolutionary algorithm (EA). EAs are stochastic optimization algorithms that use the principle of evolutionary adaptation to search for the best solution in a problem space. In an EA, members of a population undergo variation (through mutation and recombination) and selection. In other words, in each generation (iteration), new members (candidate solutions) are generated by variation, and then some of them are selected for further processing, whereas the others are discarded. Although variation is performed stochastically, selection is often on the basis of the fitness of the new members, thus mimicking the principle of survival of the fittest in biology. This sequence of variation and selection is repeated over a number of generations until individuals with better values are found, and the best individual in the population found over the entire generation is declared the best solution to the optimization problem. CMA-ES belongs to a class of EAs called evolutionary strategies (ESs). In ESs, including CMA-ES, new candidate solutions are not generated by variation. Rather, new members are sampled from a multivariate normal distribution in [symbol] ^{m}. A covariance matrix is used to describe the correlation between pairs of variables in the normal distribution. The covariance-matrix adaptation is a method to update the covariance-matrix of the multivariate normal distribution in the ES. Adapting the covariance matrix results in learning a second-order model of the objective function. However, only a few assumptions are made about the objective function, and only the ranking of candidate solutions is used for learning the sample distribution.

The CMA-ES follows a maximum-likelihood principle, modeled after the idea of increasing the probability of successful candidate solutions and search steps. The distribution mean is updated such that the likelihood of previously successful candidate solutions is increased as the distribution covariance matrix is updated, and such that the likelihood of previously successful search steps is maximized. Furthermore, two paths of the evolution of the distribution mean are computed. The evolution paths contain significant information about the correlation between any two consecutive search steps. If consecutive steps are taken in a similar direction, the evolution paths become long. One of the evolution steps is used for covariance adaptation and facilitates a faster variance increase of desirable directions. The other evolution path is used to control the step size, thereby preventing premature convergence without sacrificing the high convergence speed. The procedure in a commonly used variant of CMA-ES, called the

$$( \frac{μ}{{μ}_{w}} , λ ) \text{-} C M A \text{-} ES ,$$

is described below.

Considering an optimization problem involving the estimation of M design variables (i.e., the problem dimension is M), then at every iteration κ, the five state variables used in the CMA-ES algorithm are the distribution mean x̅^{κ}, the step size σ^{κ}, a symmetric positive definite covariance matrix C^{κ}, an isotropic evolution path \vec{p}_{σ}^{κ}, and an anisotropic evolution path \vec{p}_{c}^{κ}. The distribution mean, of dimension M, is the favorite solution to the optimization problem at the current generation. At the start of the search, the covariance matrix is set equal to an identity matrix of dimension M×M and the two evolution paths are set to zero vectors.

The algorithm then proceeds as follows. (a) Sample N_{P} candidate solutions \vec{x}ⱼ, where jε{1, 2, 3, . . . , N_{P}}, from a multivariate normal distribution [symbol] [ x̅^{κ},(σ^{κ})²C^{κ}]. This sampling amounts to a perturbation (mutation) of the current favorite solution, x̅^{κ}. In the first generation, this favorite solution is set by the user. However, in subsequent iterations, the favorite solution is the mean of a small group of candidate solutions selected from the entire population (see step c) below). N_{P} is computed as:

N_{P}=4+floor(3 log M), (8)

where the floor( ) function rounds a number to its nearest integer toward negative infinity.

The method continues with step (b) evaluate the candidate solutions on the objective function Φ: [symbol] ^{m}→ [symbol] and sort the candidate solutions in order of increasing objective-function value; i.e., the candidate with the best (lowest in a minimization problem) objective-function value is placed in the first position and the one with the worst (largest in a minimization problem) objective-function value is placed in the last position.

The method continues with step (c) compute a new distribution mean as:

$${\overline{x}}^{κ} = {\sum }_{j = 1}^{{n}_{p}} {w}_{j} {{x}^{->}}_{j : {N}_{p}}^{κ} , \qquad ( 9 )$$

where the positive weights w₁≧w₂≧ . . . ≧wₙ_{_{P}}≧0 sum to unity, and typically

$${n}_{P} \leq \frac{{N}_{P}}{2} .$$

In this formula for the new distribution, only a fraction of the population is used in computing the distribution mean. This fraction includes the best members of the population. (d) By use of the most recent distribution mean x̅^{κ} and the most recent step size σ^{κ}, update the isotropic evolution path \vec{p}_{σ}^{κ+1}. (e) By use of the isotropic evolution path \vec{p}_{σ}^{κ+1} computed in step d), update the step size σ^{κ+1}. (f) By use of the most recent mean x̅^{κ}, the most recent step size σ^{κ+1} and the isotropic evolution path \vec{p}_{σ}^{κ+1}, update the anisotropic evolution path \vec{p}_{c}^{κ+1}. (g) Update the covariance matrix C^{κ+1}. (h) Repeat steps (a) through (f) until convergence. It should be noted that at the first generation, the two evolution paths are set to zero vectors and the covariance matrix is set to an identity matrix.

The differential evolution (DE) algorithm is a type of EA that solves an optimization problem by trying to improve candidate solutions iteratively. The DE makes only a few assumptions about the problem being solved and is able to search a large dimensional space. However, there is no guarantee that the DE or any other metaheuristic algorithm will find the global optimum point. The DE iterates through several generations. At each generation, the DE maintains a population of candidate solutions (also called agents), creates new candidates by combining existing ones (mutation), and then keeps those solutions with the best fitness value (selection). Members are chosen randomly from the current pool of solutions and combined to create new candidates. The new candidates are then mixed with a predetermined target vector in a process known as recombination. Recombination yields trial vectors, and any trial vector is accepted only if it has a better fitness value than the vector from which it was produced.

In order to optimize a function Φ with M real parameters; the DE is initialized with a (random) population of N_{P} agents (parameter vectors) \vec{x}ⱼ, where jε{1, 2, 3, . . . , Nₚ}, generated uniformly in the interval (\vec{x}_{L}, \vec{x}_{U}), where \vec{x}_{L} and \vec{x}_{U} are the lower and upper limits of the agents, respectively. Then, DE iteratively solves the optimization problem with the following steps. (a) For a given parameter vector \vec{x}ⱼ^{κ} at each iteration κ, randomly select three other vectors \vec{x}ᵣ_{₁}^{κ}, \vec{x}ᵣ_{₂}^{κ} and \vec{x}ᵣ_{₃}^{κ} from the population such that the indices j, r₁, r₂ and r₃ are distinct. (b) Add the weighted difference of two of the vectors to the third as:

νⱼ^{κ+1}=\vec{x}ᵣ_{₁}^{κ}+F(\vec{x}ᵣ_{₂}^{κ}−\vec{x}ᵣ_{₃}^{κ}), (10)

where the mutation factor F is a constant in the range (0,2) and \vec{ν}ⱼ^{κ+1} is called the “donor vector”. The procedure for creating the donor vector is called “mutation”. (c) A trial vector \vec{y}ⱼ^{κ+1} is created from the target vector \vec{x}ⱼ^{κ} and the donor vector \vec{ν}^{κ+1} by replacing elements of the target vector with corresponding elements from the donor vector with a crossover probability, CR, as:

$${y}_{m , j}^{κ + 1} = \{ \begin{matrix}{v}_{m , j}^{κ + 1} & if \dot{r} \leq CR or m = {m}_{rand} \\ {x}_{m , j}^{κ} & if \dot{r} > CR or m \neq {m}_{rand}\end{matrix} , \qquad ( 11 )$$

where mε(1, 2, . . . , M), \dot{r} is a uniformly distributed random number sampled from (0,1), m_{rand} is a random integer from 1 to M, and m_{rand} ensures that \vec{ν}ⱼ^{κ+1}≠\vec{x}ⱼ^{κ+1}. This procedure is known as “recombination”. (d) The target vector \vec{x}ⱼ^{κ} is compared with the trial vector \vec{y}ⱼ^{κ+1}, and the one with the lowest function value is admitted to the generation (iteration):

$${{x}^{->}}_{j}^{κ + 1} = \{ \begin{matrix}{{y}^{->}}_{j}^{κ + 1} & if Φ ( {{y}^{->}}_{j}^{κ + 1} ) \leq Φ ( {{x}^{->}}_{j}^{κ} ) \\ {{x}^{->}}_{j}^{κ} & otherwise\end{matrix} \qquad ( 12 )$$

for all jε(1, 2, . . . , N_{P}). This procedure is known as “selection”. (e) Mutation, recombination and selection are repeated in that order until a predetermined stopping criterion is reached. (f) At the last generation, select the agent from the population that has the lowest cost function and return it as the best candidate solution found. The parameters F, CR and N_{P} of DE should be carefully selected to ensure good performance of the algorithm.

In the present method, the population size of the CMA-ES was obtained using equation (8). The DE strategy used is known as “DE/best/1 with jitters”, which gives faster convergence than many other DE strategies, and is particularly suitable for optimizing problems of small dimensions. In the DE optimizer, F is set at 0.85, CR is chosen to be 0.95, and the population size is set to 120 and run through 50 generations.

In each of the following three examples, the optimization problems were solved for three separate cases. In the first case, referred to as “Case NPV”, maximization of the NPV alone was considered. In this case, at every generation, the agent with the best NPV value is recorded. This agent has N values of VRR corresponding to the years of operating the field. The closest VRR to unity and the farthest VRR from unity are also recorded for this agent. The VRR closest to unity is termed the “best VRR” while the VRR farthest from unity is termed the “worst VRR”. Thus, every agent, including the global best agent, has a worst VRR as well as a best VRR value. In the second case, referred to as “Case VRR”, the weighted sum of all the absolute VIRs (given by equation (4) above) is optimized and the agent with the lowest objective function value is recorded, along with its NPV, its best VRR (closest to unity) and its worst VRR (farthest from unity). The third case, referred to as “Case MOBJ”, is divided into four sub-cases involving the optimization of the objective function in equation (7), where each sub-case has a distinct value of α.

In each example, the values of α are chosen to lie between zero and the number of years of waterflood, although the value could be higher than this upper limit imposed. It is expected that as the value of α tends towards zero, the MOBJ would behave like Case VRR, and as its value increases, the behavior of Case MOBJ would tend towards that of Case NPV. In each of these sub-cases, the NPV, the worst VRR and the best VRR of the current best agent (“best” based on the objective function in equation (7)) are recorded at each iteration of the stochastic search. While in a purely deterministic situation, the expectation is that the NPV obtained from Case NPV should be higher than that obtained from any of the sub-cases of Case MOBJ, and that the VRR obtained from Case VRR should be closer to unity than the VRR obtained from any of the sub-cases of MOBJ, this is not guaranteed in a single realization of the optimized results in a stochastic optimization method. The randomness of the search makes it possible that a Case MOBJ with some large value of a might yield a higher NPV than Case NPV in a single realization. However, on average (from many realizations), the NPV from Case NPV is expected to be higher.

Only vertical wells are used in the examples and the cost of each well is assumed to be $2.5×10⁶. The price of oil, the costs of water injection and disposal, and the operating cost are assumed to be constant throughout the period of operation. Overall, the method of well placement includes the following steps, where the evolutionary algorithm may be either the covariance matrix adaptation evolution strategy algorithm, to optimize the ic-th iteration of the multi-objective function Φ_{MOBJ,κ}, or the differential evolution algorithm: (a) establishing a set of well position vectors \vec{x}ᵢ for j=1, . . . , Nₚ, where Nₚ represents a number of well positions of a set of potential well positions and storing the set of well position vectors \vec{x}ⱼ in computer readable memory; (b) setting an integer κ equal to one; (c) applying an evolutionary algorithm to optimize a κ-th iteration of a multiobjective function Φ_{MOBJ,κ} for each of the well position vectors \vec{x}ⱼ in a waterflooding project by iteratively maximizing a net present value NPV_{κ} and minimizing an absolute voidage imbalance ratio |VIR|_{κ} over j=1, . . . , Nₚ, where VIR is given by VIR=VRR−1, and VRR is a voidage replacement ratio, where the multiobjective function is defined by

$${Φ}_{MOBJ , κ} = - \frac{N P {V}_{κ}}{{β}_{{NPV}_{κ = 1}}} + \frac{1}{α} {\sum }_{n = 1}^{N} \frac{{\vert V I R \vert}_{n , κ}}{{β}_{{\vert VIR \vert}_{n , κ = 1}}} ,$$

where β_{NPV}_{_{κ=1}} is a scaling factor set to a median fitness value in a population of the evolutionary algorithm at the first iteration, β_{|VIR|}_{_{n,κ=1}} is a scaling factor set to the median fitness value in the population of the evolutionary algorithm at the first iteration at year n, where n ranges between one and N, where N is a total number of years of reservoir waterflooding, a being an integer scaling factor ranging between one and N; (d) determining a well position vector for the κ-th iteration \vec{x}_{j,k} such that the net present value NPV_{κ} is maximized and the absolute voidage imbalance ratio |VIR|_{κ} is minimized from the optimization of the κ-th iteration of the multiobjective function Φ_{MOBJ,κ}; (e) storing the well position vector for the K-th iteration \vec{x}_{j,κ} which maximizes the net present value NPV_{κ} and minimizes the absolute voidage imbalance ratio |VIR|_{κ} in computer readable memory; and (f) comparing the net present value NPV_{κ} and the absolute voidage imbalance ratio |VIR|_{κ} for each iteration κ, incrementing κ by one and returning to step (c) if NPV has not been maximized and VIR has not been minimized, otherwise displaying the well position vector \vec{x}_{j,κ} which represents an optimized well position where the NPV is maximized and the VIR is minimized.

### Example 1

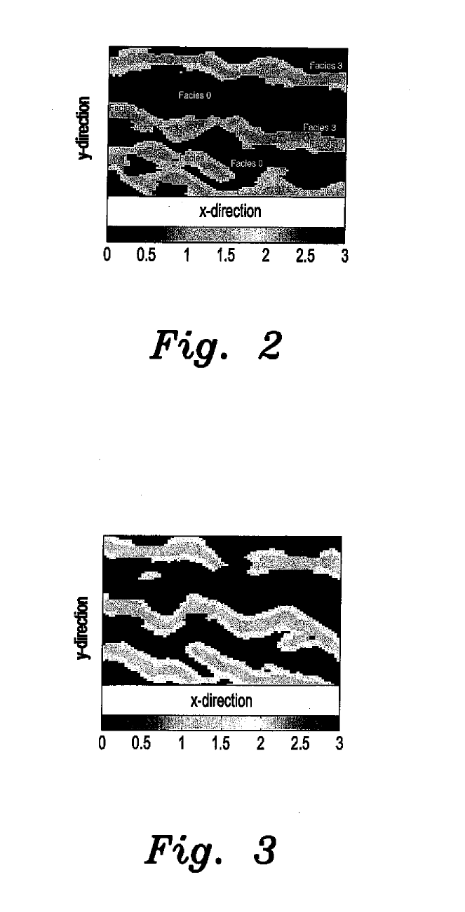

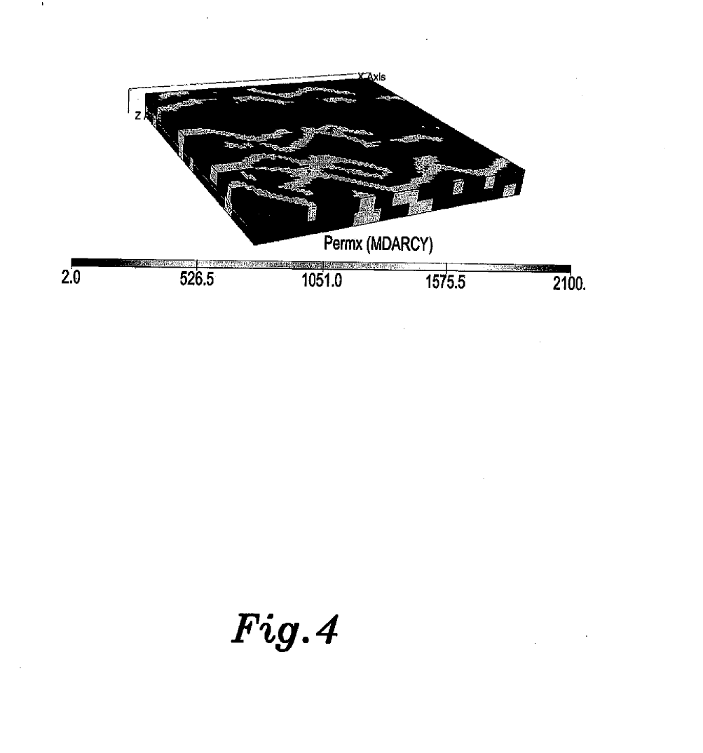

In the field of reservoir characterization, the term “facies” refers to the characteristics of a rock unit that reflect its origin and permit its differentiation from other rock units around it. Facies are typically characterized using all of the geological characteristics known for that rock unit. In reservoir characterization and reservoir simulation, the facies properties that are most important are the petrophysical characteristics that control the fluid behavior in the facies. In the first example, a synthetic channel reservoir composed of four facies in two layers was used. As shown in FIGS. 2, 3 and 4, the facies are represented by different shades of grayscale. Each facies has a distinct permeability and porosity. The reservoir is discretized into gridblocks, each block having a size of 600 feet×600 feet×200 feet. The reservoir contains undersaturated oil originally at connate water saturation, and it is to be operated above its bubble point throughout the waterflood period. Thus, gas is not expected to flow in the reservoir.

Eight producers and four injectors are to be placed in the reservoir, and the reservoir is to be produced above its bubble point pressure of 1900 psi. The wells are controlled by the bottomhole pressure (BHP). The producers are to operate at a constant BHP of 2800 psi, while the injectors are to operate at 4500 psi. All producers and injectors are to be drilled at the beginning of the project, and the time for calculating the NPV is 20 years of field operation. The overall problem is to find the best configuration of wells that provides a high NPV while, at the same time, ensuring that the VRRs are close to one (i.e., unity) over the 20 years of operation. Since each well has two Cartesian coordinates, x and y, to be determined, the total number of variables to be optimized is 24. Additionally, because there are 20 years of waterflood operation, the total number of objectives to be optimized is 21, including a single NPV and 20 absolute voidage imbalance ratios.

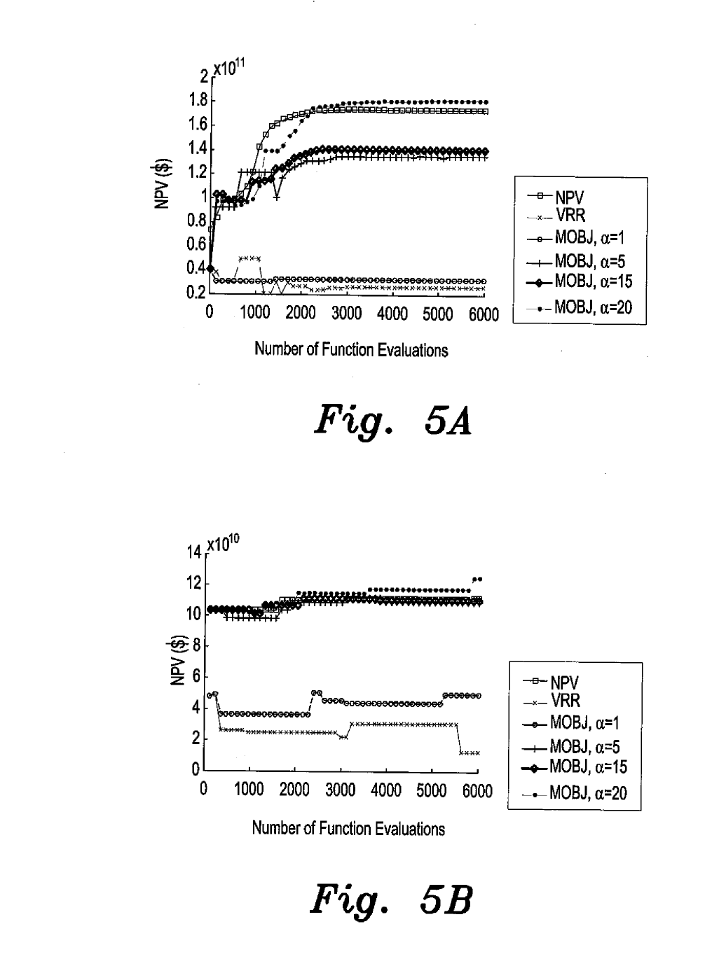

In the first and second cases, −NPV and absolute VIR are minimized, respectively. In the third case, the value of α is set to 1, 5, 15 and 20 for different respective sub-cases of MOBJ. FIGS. 5A and 5B show the NPV obtained by optimizing the NPV, the VRR and the four cases of the multi-objective function. It can be seen that the NPV attained by each optimizer is much higher when only the NPV is optimized than when only the VRR is optimized. This illustrates that significant loss in profit can be incurred if only the VRR is taken into consideration in the optimization process. In the case of the multiobjective function (MOBJ), the NPV attained by the optimizers gradually increased with an increasing value of a. Beyond a certain large value of a, the MOBJ behaves much like a single objective involving only NPV. It can be seen in this example that Case MOBJ with α=20 yields a higher NPV than Case NPV.

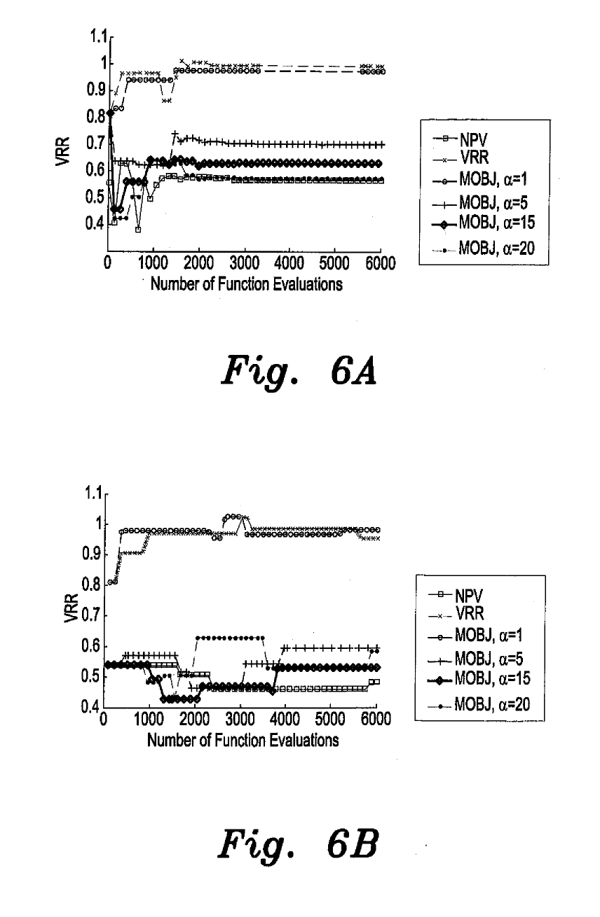

FIGS. 6A and 6B show the worst VRRs recorded in any of the 20 years of waterflooding by the global best agent. The farthest values of VRR (from unity) were obtained when NPV was used as the sole objective function. When the weighted sum of absolute VIRs was used as the fitness function, the closest VRR to unity was obtained. When MOBJ was used, it can be seen that small values of α yielded good values of VRR, while large values of α gave poor VRRs. In Case NPV and Case MOBJ, where α=1, the worst recorded VRR values, as shown in FIGS. 6A and 6B, are already very close to unity. This shows the importance of optimizing the VIR with regard to environmental protection.

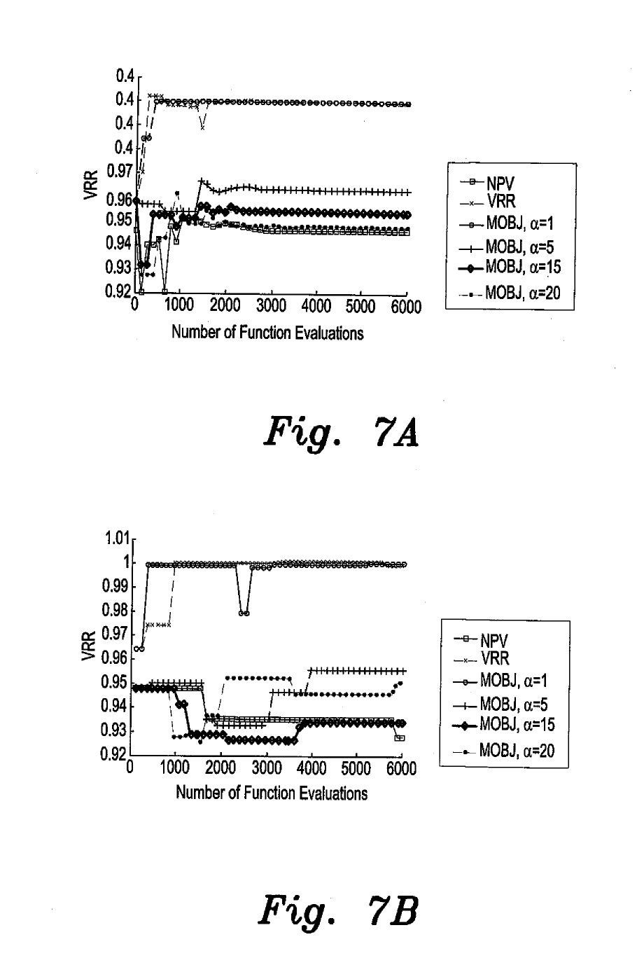

FIGS. 7A and 7B shows the best VRR obtained under the three cases considered. It can again be seen that both Case NPV and Case MOBJ, with α=1, yielded VRR values that are closer to unity than the values obtained from the other cases. As the value of a increased, the VRR values obtained became poorer, indicating that α can be used to control the trade-off between the quest for a high profit and the attempt to satisfy regulatory requirements of government and environmental agencies. It can also be seen that as the value of α became smaller, the MOBJ behaved as if only the VRR was optimized. Thus, controlling the value of a can help achieve a balance between the NPV and the VRR.

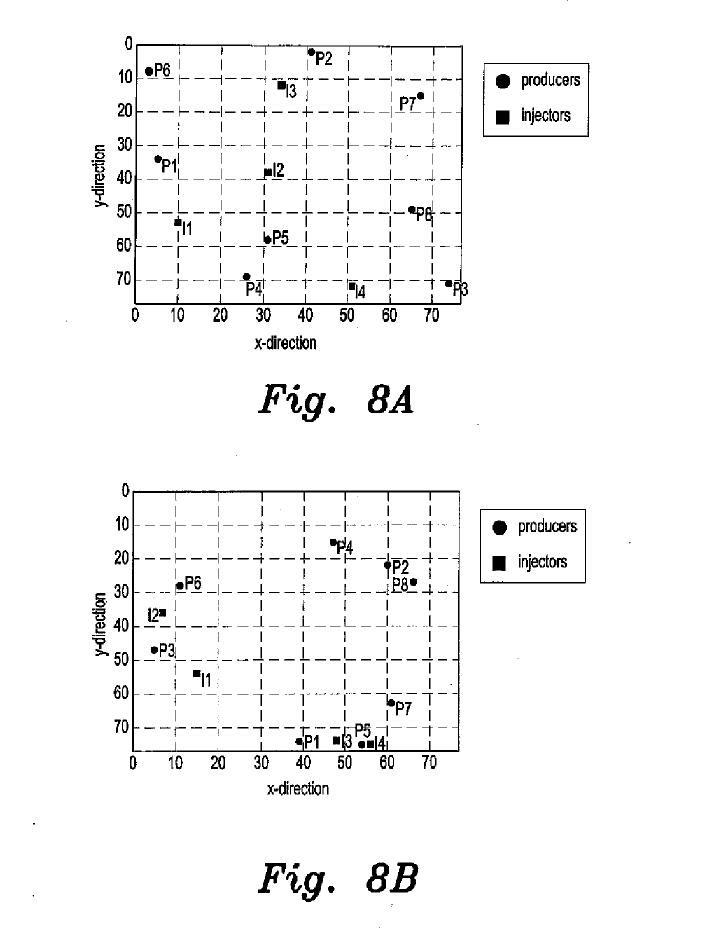

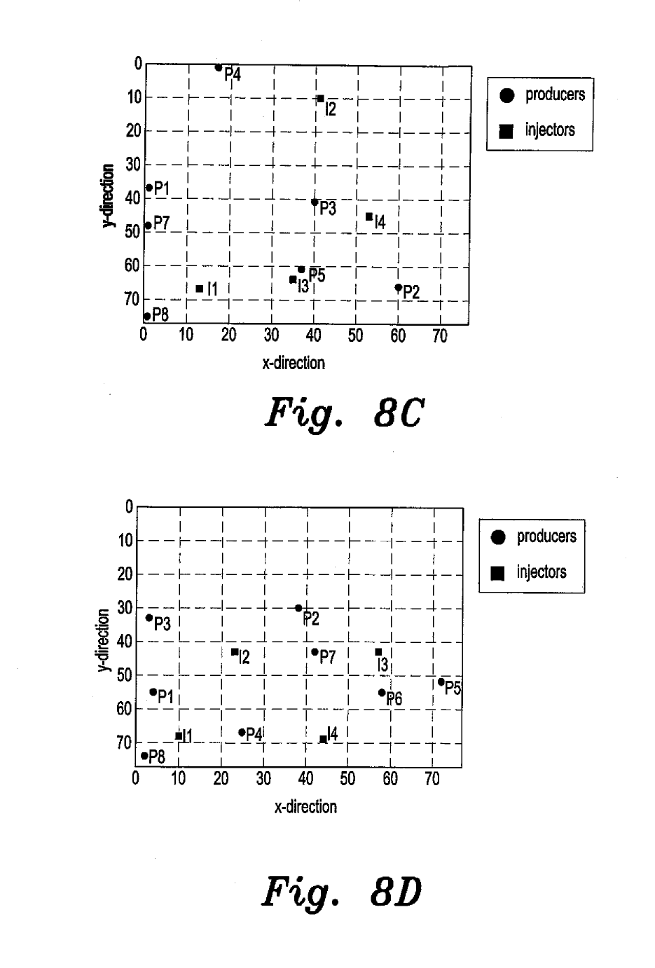

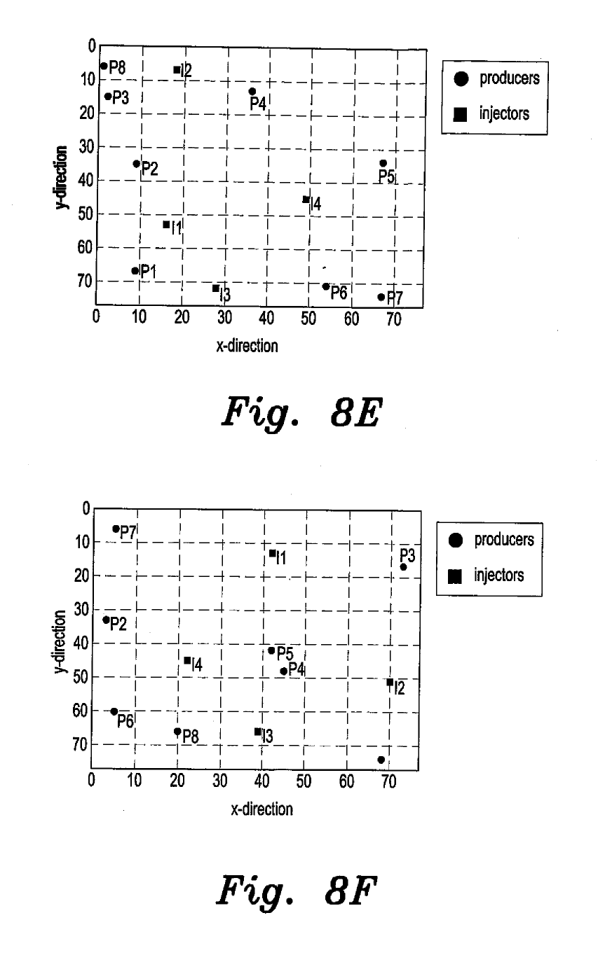

FIGS. 8A-8F show the well configurations obtained by the CMA-ES for the cases studied. In FIGS. 8A-8F, the producers are labeled P1 to P8 and the injectors are labeled I1 to I4. The configurations are different for the different cases and are based on a 20-year investment scenario. It is important to note that the well configurations shown are the best (based on the specific objective function considered) found by the optimizer, considering the reservoir heterogeneity and the duration of the waterflood period. A different project duration, such as 50 years, is expected to yield a different set of well configurations for the objective functions considered.

### Example 2

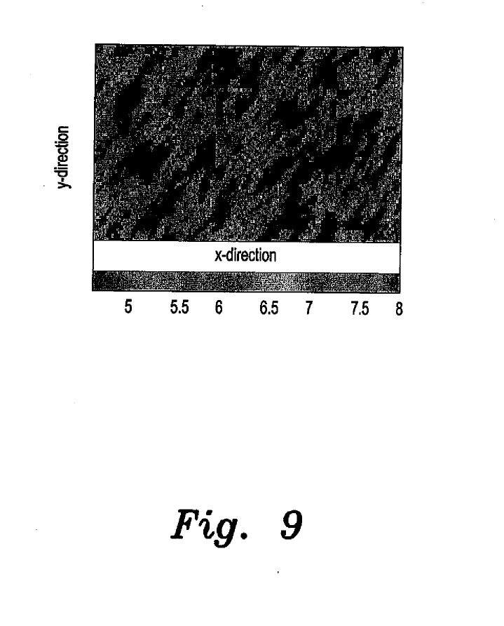

As shown in FIG. 9, the second example considers a synthetic reservoir with a distributed permeability field. The reservoir is discretized into 128×64 grid blocks, each block having a size of 300 feet×300 feet×300 feet. The reservoir also contains undersaturated oil produced at pressures above its bubble point of 1900 psi. The wells are controlled by the bottomhole pressure (BHP). The producers are to be operated at a constant pressure of 2800 psi, while the injectors are to be operated at 5500 psi. Any producer is shut off if it produces at more than 95% water cut or at less than 100 stb/day. All producers and injectors are drilled at the beginning of the project. The overall problem is to find the optimum configuration of nine wells (five producers and four injectors) that gives a high NPV and acceptable VRR over a 12-year operating period. Three cases similar to those in Example 1 are considered, except that the values of α in the four sub-cases of the MOBJ are 0.1, 1, 6 and 12. These values are chosen in this example to be between zero and the number of years of waterflood. They may, however, be any positive real number.

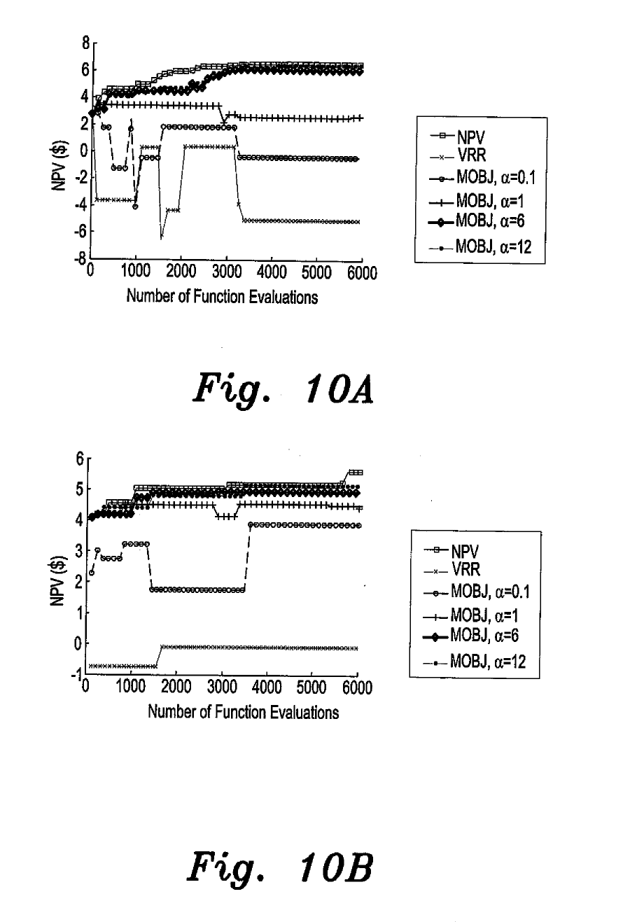

FIGS. 10A and 10B show the NPVs obtained in all cases. The two optimizers gave the highest NPVs when NPV alone was optimized (Case NPV) and the lowest NPVs when VRR alone was optimized (Case VRR). The values of NPV given by the various sub-cases of Case MOBJ fall between those given by Case NPV and Case VRR, with the NPV gradually increasing as a increased. In this example, the two optimization algorithms gave negative NPVs (losses) when only the VRR was optimized. When α=0.1, the CMA-ES also gave a negative NPV. This clearly shows that optimizing the VRR alone or selecting too small values of α in the MOBJ may result in unfavorable projects and loss of investments.

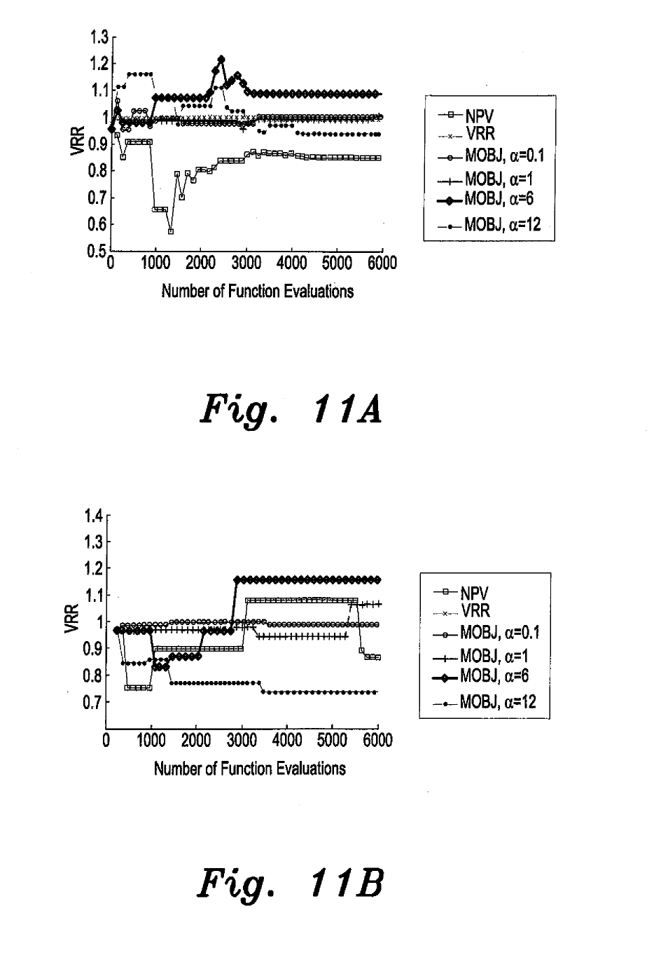

FIGS. 11A and 11B show the worst VRR values obtained in any of the 12 operating years by the optimizers. As expected, the VRR attained by Case NPV is the farthest VRR from unity, while that obtained by Case VRR is the closest VRR to unity. The sub-cases of MOBJ gave values of VRR between those given by Case NPV and Case VRR. Setting α=0.1 gave almost the same VRR as that attained by Case VRR.

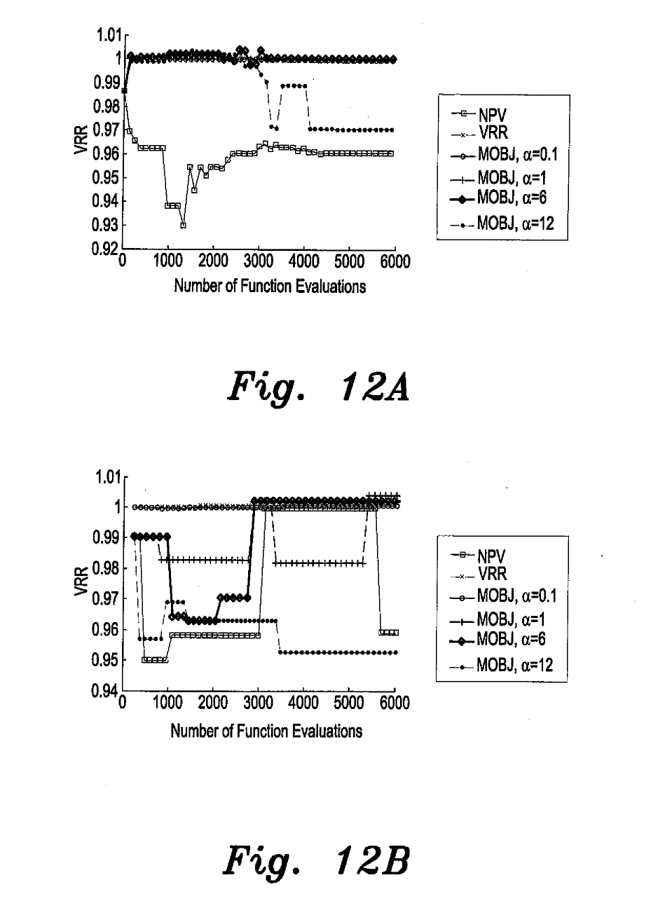

In FIGS. 12A and 12B, it can be seen that the closest VRR to unity was obtained when only VRR was optimized. Additionally, in Case MOBJ, smaller values of α attained VRR values closer to unity than Case MOBJ with larger values of α. The farthest values of VRR (from unity) were obtained when only NPV was optimized. It can also be seen that the VRR values in this example are closer to unity than the worst VRR values obtained in Example 1.

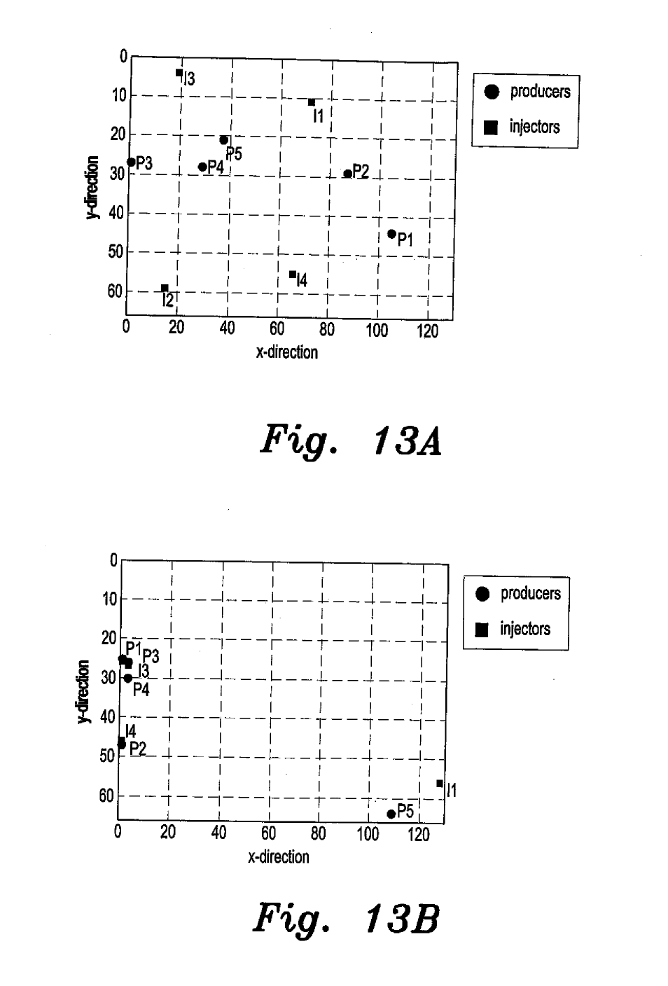

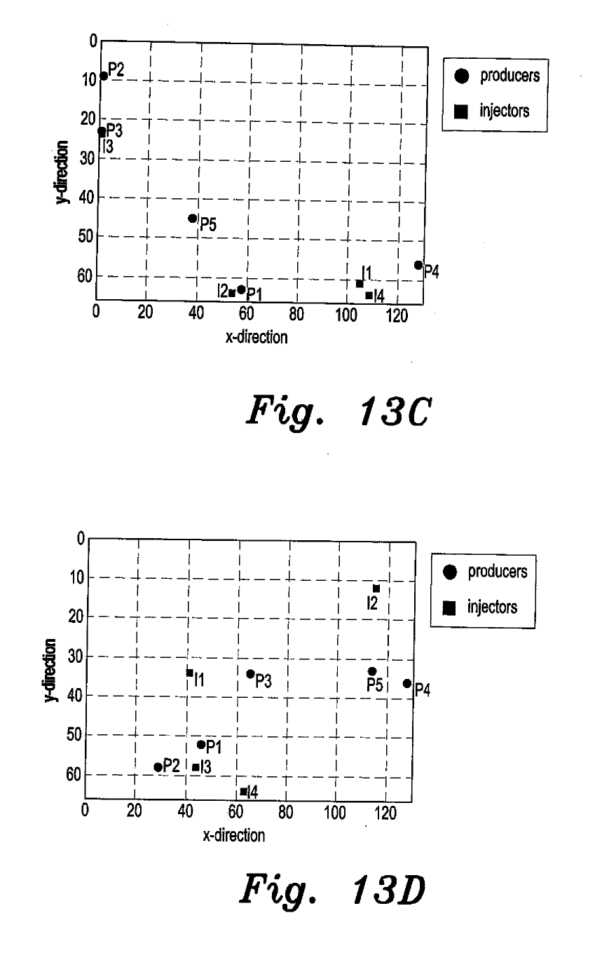

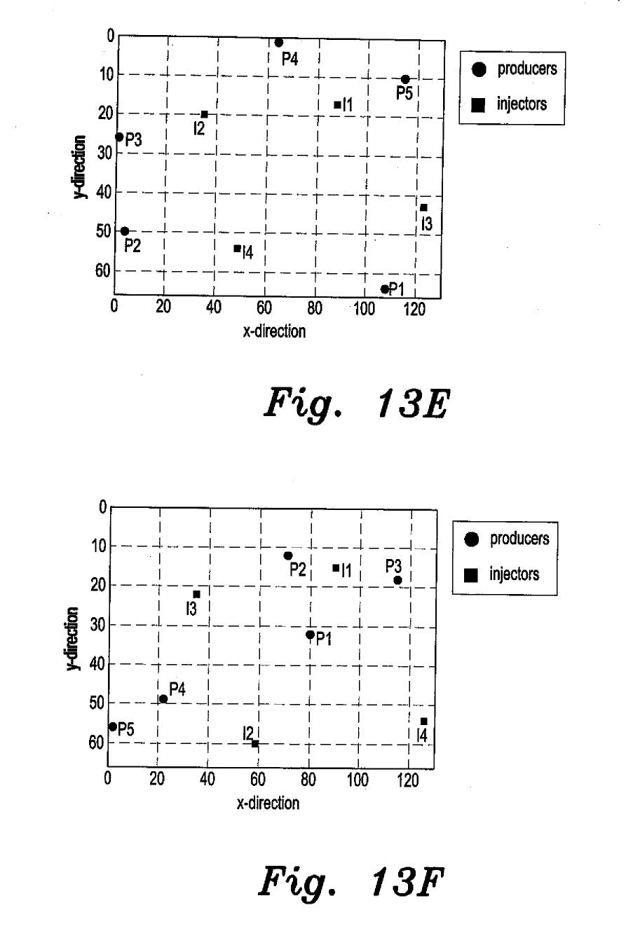

FIGS. 13A-13F show the well locations obtained by running the CMA-ES on Example 2. It can be seen that some of the optimized well locations are crowded, particularly when the VRR is given preference over the NPV (FIGS. 13B and 13C). In particular, the injectors and producers tend to be positioned close to each other. Such configurations are expected when the objective is mainly to balance the fluid supply to the reservoir with fluid withdrawal from the reservoir. Optimizing the VRR alone or assigning a bigger weight to the VRR ensures that wells are placed in such a way as to attain this balance. In such cases, where the wells appear to be too close to one another, the optimized well configurations should be checked against the minimum safe distance to place adjacent wells to ensure no physical constraint is violated. In cases of violations of the minimum safe distance, such configurations should be rejected. By gradually increasing the value of α, a gradual shift from a crowded well configuration can be obtained. A more effective way to ensure that the minimum safe distances between any two wells are not violated is to perform a constrained well placement optimization.

### Example 3

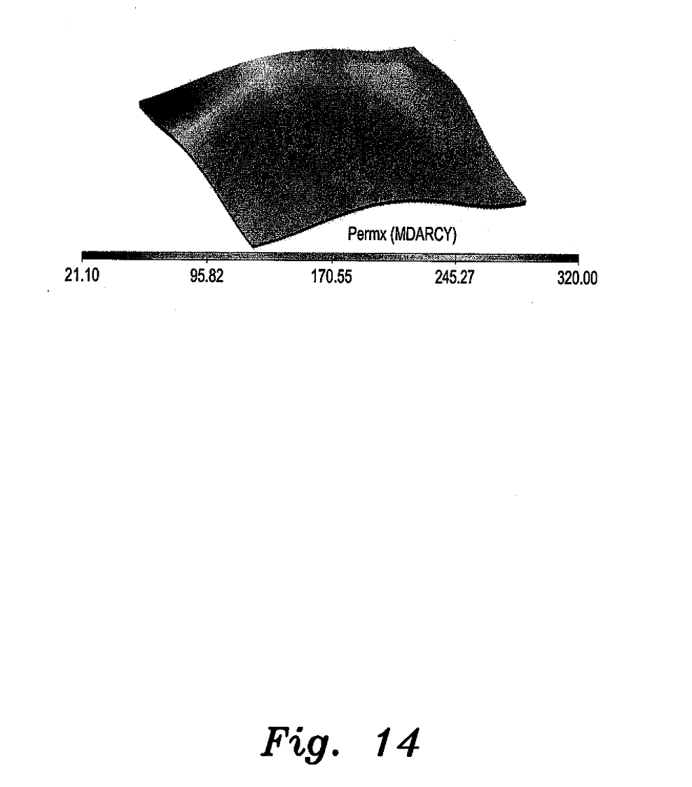

In the third example, an anticlinal reservoir discretized into 85×75×4 grid blocks is considered. Each grid block is 200 feet long and 200 feet wide. However, the grids have different thicknesses ranging from about 30 feet to about 60 feet. The reservoir permeability and porosity are slightly heterogeneous, as shown in FIG. 14. The reservoir contains undersaturated oil with a bubble point pressure of 1750 psi. However, unlike the reservoirs in Examples 1 and 2, this reservoir is allowed to produce fluids at below its bubble point pressure, making it possible for gas to evolve and flow in the reservoir. At surface conditions, the densities of the reservoir oil, water, and gas are 48 lb/cu. ft., 62.8 lb/cu. ft., and 0.06 lb/scf, respectively. The initial pressure of the reservoir at 7100 feet is 2070 psi. At the reference pressure (2070 psi), the isothermal compressibility of water is 3×10⁻⁶ and its formation volume factor is 1.02 bbl/stb. Rock isothermal compressibility at the reference pressure is 4×10⁻⁶. Initial reservoir saturation is assumed uniform throughout the reservoir and equal to connate water saturation.

The ultimate problem is to place nine producers and six injectors in this reservoir based on a 25-year investment plan. The production wells are to be produced at a total liquid rate of 2200 stb/day, subject to a minimum bottomhole pressure (BHP) of 1200 psi. The producers are further subjected to economic limits of 100 stb/day minimum oil production rate and maximum water cut of 95%. The injectors are to be operated at a constant rate of 3500 stb/day, subject to a maximum BHP of 4000 psi.

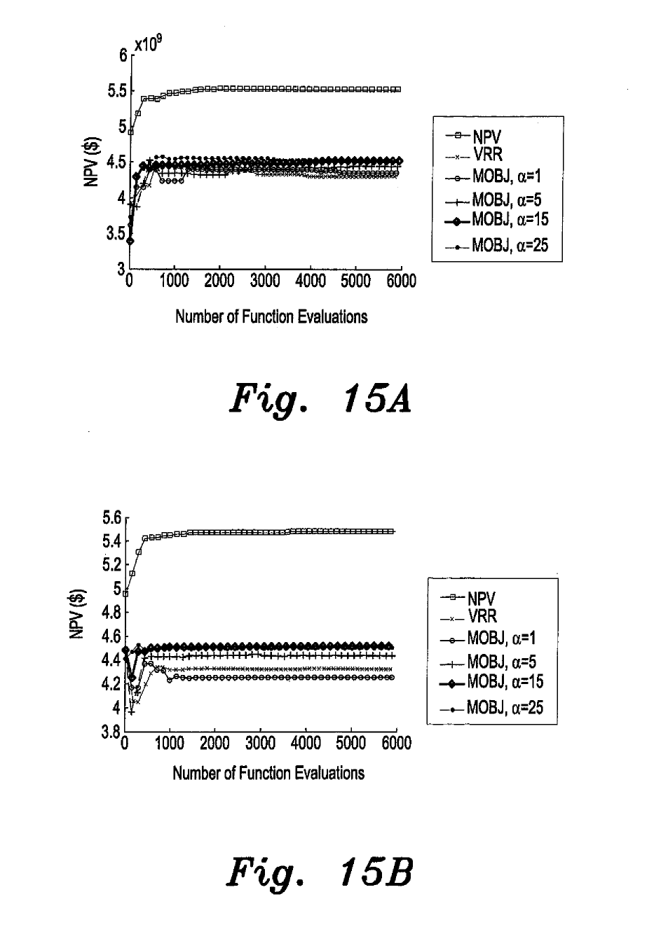

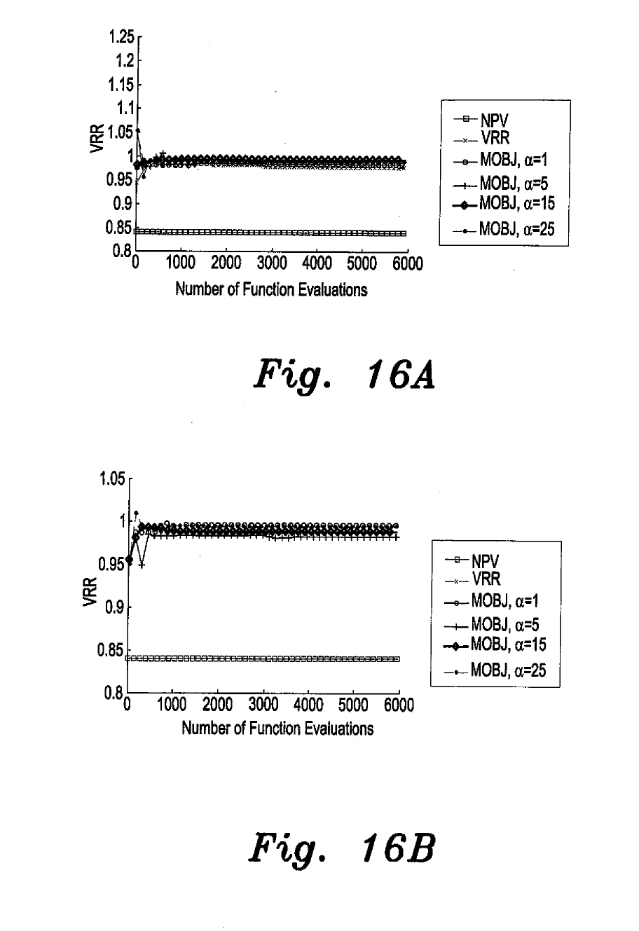

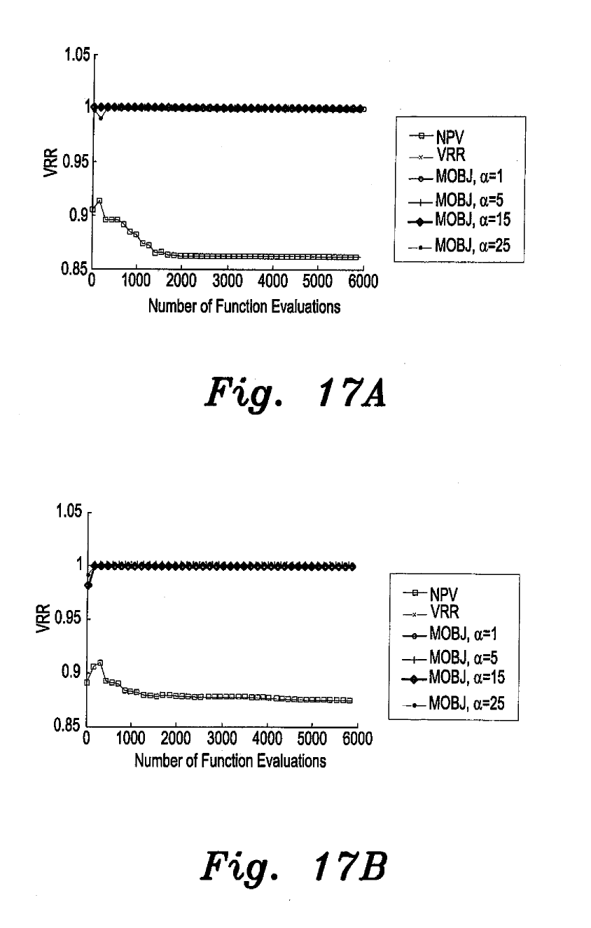

Optimized NPVs, VRRs, and well configurations were obtained for Case NPV, Case VRR and four sub-cases of MOBJ. In the four sub-cases of MOBJ, the value of α is set at 1, 5, 15 and 25, respectively. FIGS. 15A-17B show the results of the optimization on this reservoir. A much higher NPV was obtained when NPV was the sole objective function (FIGS. 15A and 15B). Lower values of NPV were obtained as the VRR became increasingly important. FIGS. 16A and 16B and FIGS. 17A and 17B both indicate that Case NPV gave the worst values of VRR, further indicating the trade-off between optimizing the NPV and optimizing the VRR.

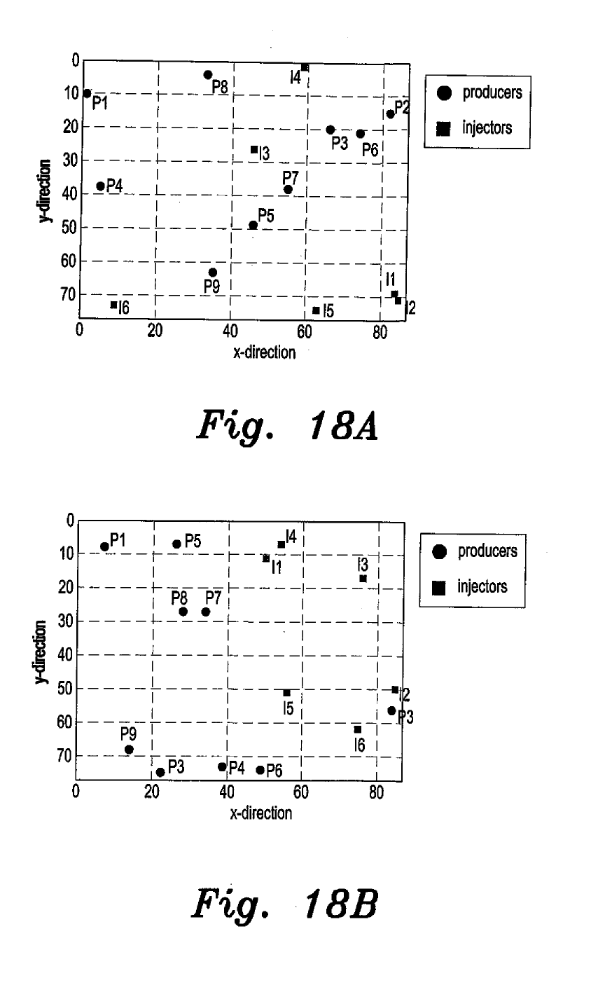

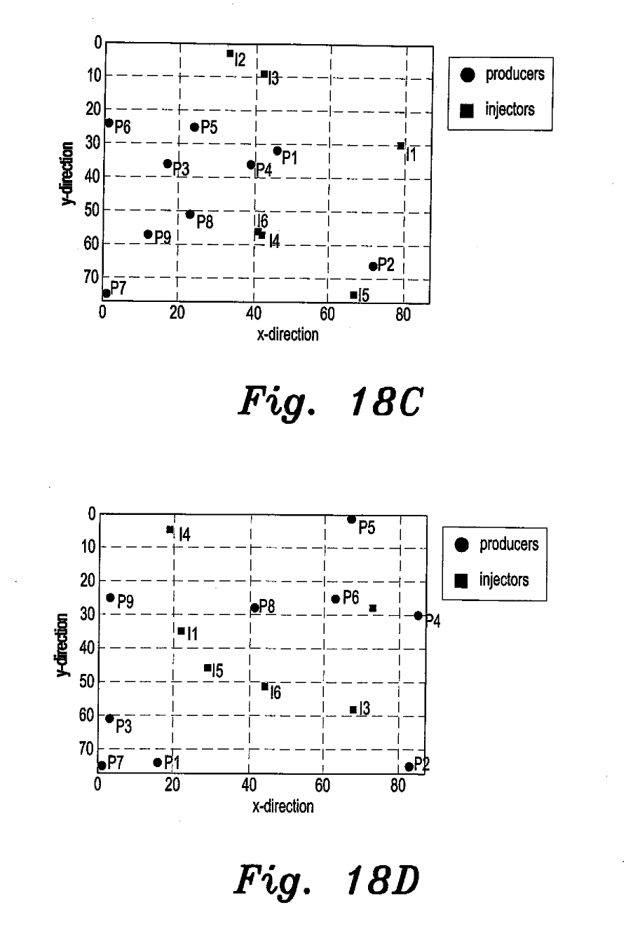

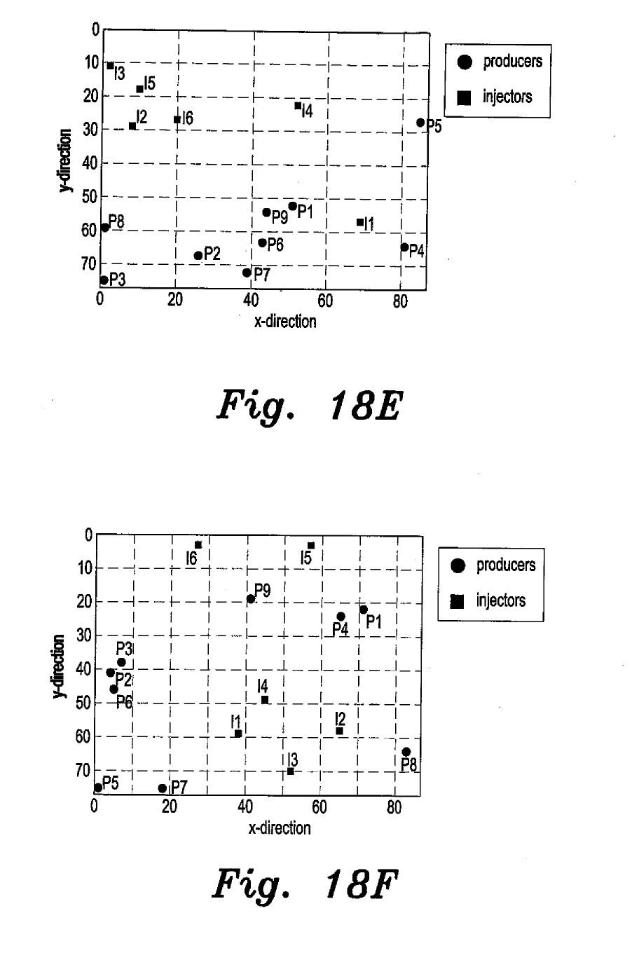

FIGS. 18A-18F show the well configurations produced by the different cases of objectives. These configurations are based on the 25-year investment plan used in this example. It should be understood that the optimal well configuration will be different if a different waterflood (or investment) duration is used in determining the objective function.

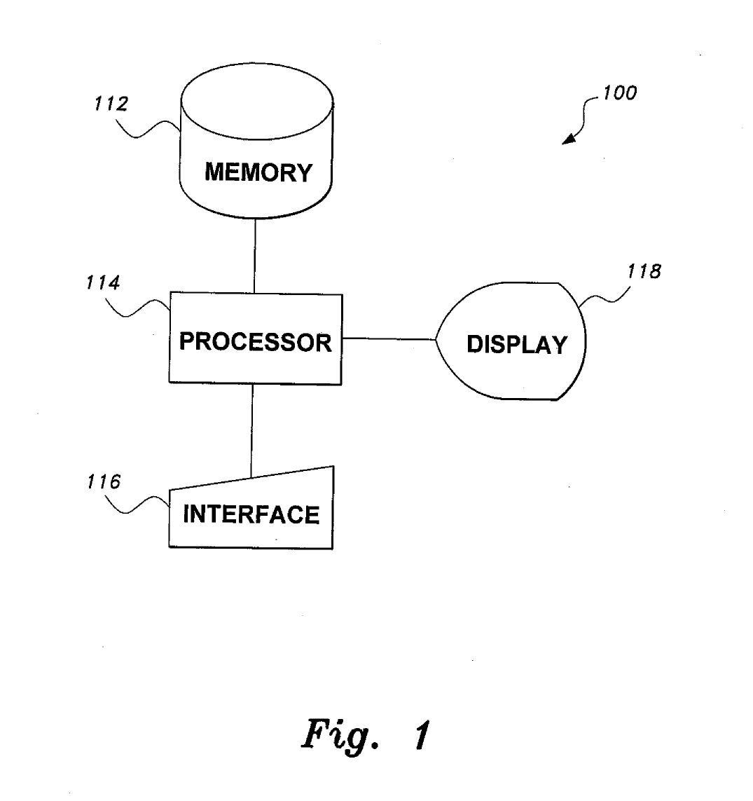

It should be understood that the calculations may be performed by any suitable computer system, such as that diagrammatically shown in FIG. 1. Data is entered into system 100 via any suitable type of user interface 116, and may be stored in memory 112, which may be any suitable type of computer readable and programmable memory and is preferably a non-transitory, computer readable storage medium. Calculations are performed by processor 114, which may be any suitable type of computer processor and may be displayed to the user on display 118, which may be any suitable type of computer display.

Processor 114 may be associated with, or incorporated into, any suitable type of computing device, for example, a personal computer or a programmable logic controller. The display 118, the processor 114, the memory 112 and any associated computer readable recording media are in communication with one another by any suitable type of data bus, as is well known in the art.

Examples of computer-readable recording media include non-transitory storage media, a magnetic recording apparatus, an optical disk, a magneto-optical disk, and/or a semiconductor memory (for example, RAM, ROM, etc.). Examples of magnetic recording apparatus that may be used in addition to memory 112, or in place of memory 112, include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW. It should be understood that non-transitory computer-readable storage media include all computer-readable media, with the sole exception being a transitory, propagating signal.

It is to be understood that the present invention is not limited to the embodiments described above, but encompasses any and all embodiments within the scope of the following claims.

We claim:

1. A computer software product, comprising a non-transitory computer readable storage medium having a set of instructions executable by a processor stored thereon for optimizing well placement, the instructions including:
(a) a first set of instructions which, when loaded into main memory and executed by the processor, causes the processor to set an integer κ equal to one;
(b) a second set of instructions which, when loaded into main memory and executed by the processor, causes the processor to apply an evolutionary algorithm to optimize a κ-th iteration of a multiobjective function Φ_{MOBJ,κ} for a well position vector \vec{x}ⱼ in a waterflooding project by iteratively maximizing a net present value NPV_{κ} and minimizing an absolute voidage imbalance ratio |VIR|_{κ} over j=1, . . . , Nₚ, where Nₚ represents a number of well positions of a set of potential well positions, VIR is given by VIR=VRR−1, and VRR is a voidage replacement ratio, wherein the multiobjective function is defined by:
$${Φ}_{MOBJ , κ} = - \frac{N P {V}_{κ}}{{β}_{{NPV}_{κ = 1}}} + \frac{1}{α} {\sum }_{n = 1}^{N} \frac{{\vert V I R \vert}_{n , κ}}{{β}_{{\vert V I R \vert}_{n , κ = 1}}} ,$$
where β_{NPV}_{_{κ=1}} is a scaling factor set to a median fitness value in a population of the evolutionary algorithm at the first iteration, β_{|VIR|}_{_{n,κ=1}} is a scaling factor set to the median fitness value in the population of the evolutionary algorithm at the first iteration at year n, wherein n ranges between one and N, where N is a total number of years of reservoir waterflooding, α being an integer scaling factor ranging between one and N;
(c) a third set of instructions which, when loaded into main memory and executed by the processor, causes the processor to determine a well position vector for the κ-th iteration \vec{x}_{j,κ} such that the net present value NPV_{κ} is maximized and the absolute voidage imbalance ratio |VIR|_{κ} is minimized from the optimization of the ic-th iteration of the multiobjective function Φ_{MOBJ,κ}; and
(d) a fourth set of instructions which, when loaded into main memory and executed by the processor, causes the processor to compare the net present value NPV_{κ} and the absolute voidage imbalance ratio |VIR|_{κ} for each iteration κ, increment κ by one and return to the second set of instructions if NPV has not been maximized and VIR has not been minimized, otherwise outputting the well position vector \vec{x}_{j,κ} which represents an optimized well position where the NPV is maximized and the VIR is minimized.

2. The computer software product as recited in claim 1, wherein the second set of instructions further comprises calculating |VIR|_{n,κ} as |VIR|_{n,κ}=|1−VRRₙ| for iteration κ, where:
$$V R {R}_{n} = \frac{{B}_{w , n} {Q}_{n}^{w , inj}}{{B}_{w , n} {Q}_{n}^{w , pro} + {B}_{o , n} {Q}_{n}^{o , pro} + {B}_{g , n} {Q}_{n}^{o , pro} ( G O {R}_{n} - {R}_{so , n} )} ,$$
and B_{w,n}, B_{o,n} and B_{g,n} are average formation volume factors for water, oil and gas in the year n, respectively, Qₙ^{w,inj} and Qₙ^{w,pro} are total amount of water injected and produced, respectively, in the year n, Qₙ^{o,pro} is total amount of oil produced in the year n, GORₙ is a cumulative gas/oil ratio in the year n and R_{so,n} is a solution-gas/oil ratio in the year n.

3. The computer software product as recited in claim 2, wherein the second set of instructions further comprises calculating the NPV as:
$$N P V = {\sum }_{n = 1}^{N} \frac{{CF}_{n}}{{( 1 + r )}^{n}} - {C}_{cap} ,$$
where CFₙ is cash flow in the year n, r is an annual discount rate, and C_{cap} is a capital expense given by C_{cap}=C_{facility}+N_{prod}C_{prod}+NᵢₙⱼCᵢₙⱼ, where C_{facility} is a facility-installation cost, N_{prod} is a number of producers, C_{prod} is a cost of drilling one production well, Nᵢₙⱼ is a number of injectors, and Cᵢₙⱼ is a cost of drilling an injector.

4. The computer software product as recited in claim 2, wherein the second set of instructions comprises applying a covariance matrix adaptation evolution strategy algorithm to optimize the κ-th iteration of the multi-objective function Φ_{MOBJ,κ}.

5. The computer software product as recited in claim 2, wherein the second set of instructions comprises applying a differential evolution algorithm to optimize the κ-th iteration of the multi-objective function Φ_{MOBJ,κ}.

6. A computer-implemented method for well placement, comprising the steps of:
(a) establishing a set of well position vectors \vec{x}ⱼ for j=1, . . . , Nₚ, where Nₚ represents a number of well positions of a set of potential well positions and storing the set of well position vectors \vec{x}ⱼ in computer readable memory;
(b) setting an integer κ equal to one;
(c) applying an evolutionary algorithm to optimize a κ-th iteration of a multiobjective function Φ_{MOBJ,κ} for each of the well position vectors \vec{x}ⱼ in a waterflooding project by iteratively maximizing a net present value NPV_{κ} and minimizing an absolute voidage imbalance ratio |VIR|_{κ} over J=1, . . . , Nₚ, where VIR is given by VIR=VRR−1, and VRR is a voidage replacement ratio, wherein the multiobjective function is defined by:
$${Φ}_{MOBJ , κ} = - \frac{N P {V}_{κ}}{{β}_{{NPV}_{κ = 1}}} + \frac{1}{α} {\sum }_{n = 1}^{N} \frac{{\vert V I R \vert}_{n , κ}}{{β}_{{\vert VIR \vert}_{n , κ = 1}}} ,$$
where β_{NPV}_{_{κ=1}} is a scaling factor set to a median fitness value in a population of the evolutionary algorithm at the first iteration, β_{|VIR|}_{_{n,κ=1}} is a scaling factor set to the median fitness value in the population of the evolutionary algorithm at the first iteration at year n, wherein n ranges between one and N, where N is a total number of years of reservoir waterflooding, α being an integer scaling factor ranging between one and N;
(d) determining a well position vector for the κ-th iteration \vec{x}_{j,κ} such that the net present value NPV_{κ} is maximized and the absolute voidage imbalance ratio |VIR|_{κ} is minimized from the optimization of the κ-th iteration of the multiobjective function Φ_{MOBJ,κ};
(e) storing the well position vector for the κ-th iteration \vec{x}_{j,κ} which maximizes the net present value NPV_{κ} and minimizes the absolute voidage imbalance ratio |VIR|_{κ} in computer readable memory; and
(f) comparing the net present value NPV, and the absolute voidage imbalance ratio |VIR|_{κ} for each iteration κ, incrementing κ by one and returning to step (c) if NPV has not been maximized and VIR has not been minimized, otherwise displaying the well position vector \vec{x}_{j,κ} which represents an optimized well position where the NPV is maximized and the VIR is minimized.

7. The computer-implemented method for well placement as recited in claim 6, wherein the step of applying the evolutionary algorithm further comprises calculating |VIR|_{n,κ} as |VIR|_{n,κ}=|1−VRRₙ| for iteration κ, where
$${VRR}_{n} = \frac{{B}_{w , n} {Q}_{n}^{w , inj}}{{B}_{w , n} {Q}_{n}^{w , pro} + {B}_{o , n} {Q}_{n}^{o , pro} + {B}_{g , n} {Q}_{n}^{o , pro} ( {GOR}_{n} - {R}_{so , n} )} ,$$
and B_{w,n}, B_{o,n} and B_{g,n} are average formation volume factors for water, oil and gas in the year n, respectively, Qₙ^{w,inj} and Qₙ^{w,pro} are total amount of water injected and produced, respectively, in the year n, Qₙ^{o,pro} is total amount of oil produced in the year n, GORₙ is a cumulative gas/oil ratio in the year n and R_{so,n} is a solution-gas/oil ratio in the year n.

8. The method for well placement as recited in claim 7, wherein the step of applying the evolutionary algorithm further comprises calculating the NPV as:
$$N P V = {\sum }_{n = 1}^{N} \frac{{CF}_{n}}{{( 1 + r )}^{n}} - {C}_{cap} ,$$
where CFₙ is cash flow in the year n, r is an annual discount rate, and C_{cap} is a capital expense given by C_{cap}=C_{facility}+N_{prod}C_{prod}+NᵢₙⱼCᵢₙⱼ, where C_{facility} is a facility-installation cost, N_{prod} is a number of producers, C_{prod} is a cost of drilling one production well, Nᵢₙⱼ is a number of injectors, and Cᵢₙⱼ is a cost of drilling an injector.

9. The method for well placement as recited in claim 8, wherein the step of applying the evolutionary algorithm comprises applying a covariance matrix adaptation evolution strategy algorithm to optimize the κ-th iteration of the multi-objective function Φ_{MOBJ,κ}.

10. The computer software product as recited in claim 8, wherein the step of applying the evolutionary algorithm comprises applying a differential evolution algorithm to optimize the κ-th iteration of the multi-objective function Φ_{MOBJ,κ}.
